(19) United States
(12) Patent Application Publication
(10) Pub. No.: US 2020/0315406 A1
(43) Pub. Date: Oct. 8, 2020

(54) Soap Dispenser Showerhead

(71) Applicant: Nancy Wozny-Karnik, Puyallup, WA (US)

(72) Inventor: Nancy Wozny-Karnik, Puyallup, WA (US)

(21) Appl. No.: 16/372,875

(22) Filed: Apr. 2, 2019

(51) Int. Cl. A47K 5/12; B05B 1/18; B05B 1/16

(52) U.S. Cl. CPC A47K 5/12; B05B 1/16; B05B 1/18

(57) ABSTRACT

A soap dispenser showerhead for releasing soap directly into the shower stream for easier soap application includes a showerhead comprising a handle portion and a head portion. A water flow channel extends through a bottom side of the handle portion up through the head portion to be released through a plurality of flow apertures. A valve is coupled within the water flow channel and has a valve control extending through the handle portion. A soap dispenser is selectively engageable within a cavity of the handle portion of the showerhead adjacent the valve. The soap dispenser has a storage compartment configured to store liquid soap and a nozzle in fluid communication with the storage compartment and the valve. The valve control regulates the flow of liquid soap into the water flow channel.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to showerheads and more particularly pertains to a new showerhead for releasing soap directly into the shower stream for easier soap application.

### BRIEF SUMMARY OF THE INVENTION

An embodiment of the disclosure meets the needs presented above by generally comprising a showerhead comprising a handle portion and a head portion. The handle portion has a dorsal side and a ventral side. A water flow channel extends through a bottom side of the handle portion up through the head portion to be released through a plurality of flow apertures. The bottom side has a threaded neck that is configured to receive a shower hose. A valve is coupled within the water flow channel and has a valve control extending through the handle portion. A soap dispenser is selectively engageable within a cavity of the handle portion of the showerhead adjacent the valve. The soap dispenser has a storage compartment configured to store liquid soap and a nozzle in fluid communication with the storage compartment and the valve. The valve control regulates the flow of liquid soap into the water flow channel.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a soap dispenser showerhead according to an embodiment of the disclosure.

FIG. 2 is a bottom plan view of an embodiment of the disclosure.

FIG. 3 is a side elevation view of an embodiment of the disclosure.

FIG. 4 is a rear elevation view of an embodiment of the disclosure.

FIG. 5 is a detail view of an embodiment of the disclosure.

### DETAILED DESCRIPTION OF THE INVENTION

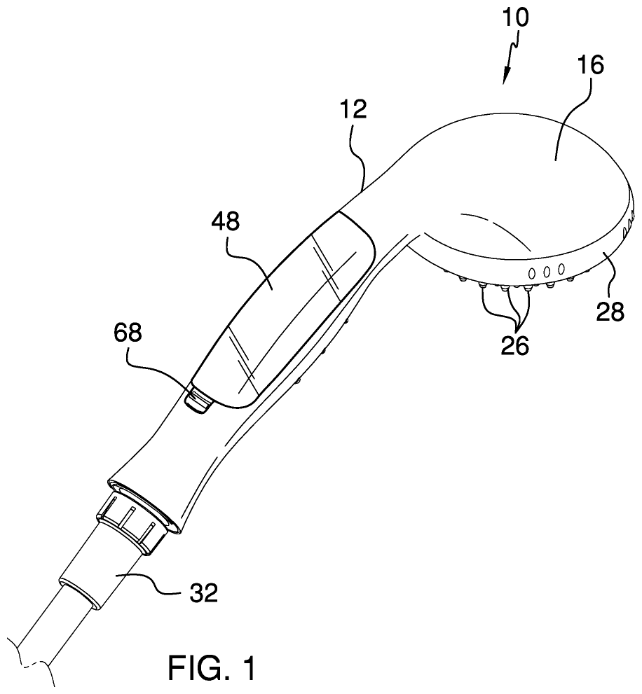

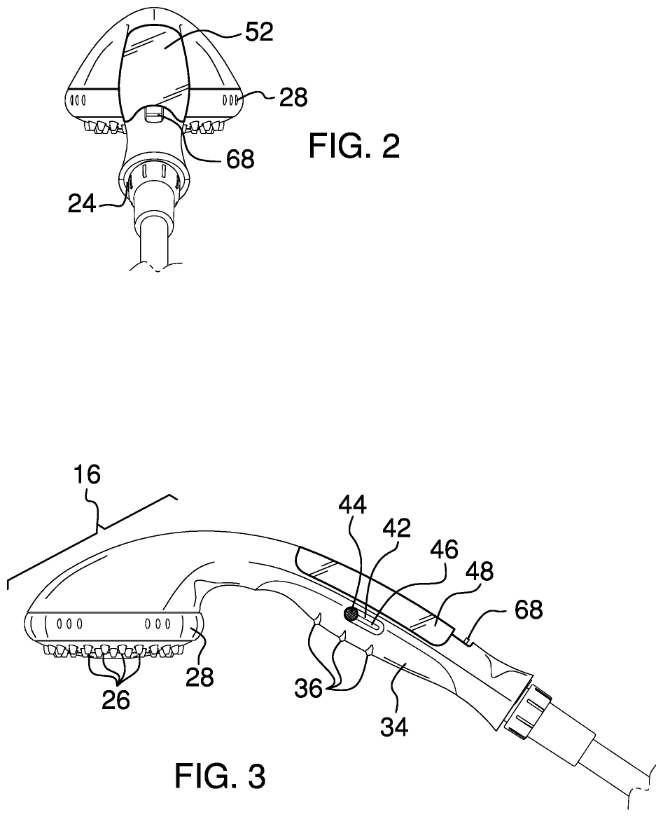

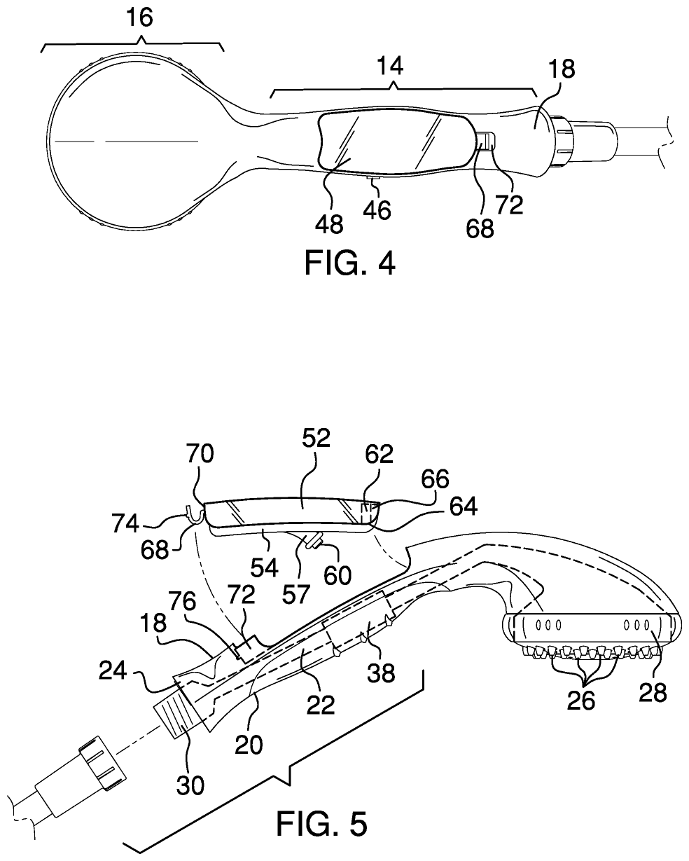

With reference now to the drawings, and in particular to FIGS. 1 through 5 thereof, a new showerhead embodying the principles and concepts of an embodiment of the disclosure and generally designated by the reference numeral 10 will be described.

As best illustrated in FIGS. 1 through 5, the soap dispenser showerhead 10 generally comprises a showerhead 12 comprising a handle portion 14 and a head portion 16. The handle portion 14 is contoured to create an ergonomic shape and has a dorsal side 18 and a ventral side 20. A water flow channel 22 extends through a bottom side 24 of the handle portion 14 up through the head portion 16 to be released through a plurality of flow apertures 26. An adjustment ring 28 may be coupled around the head portion 16 and in operational communication with the plurality of flow apertures 26 to create different flow patterns and pressures. The bottom side 24 has a threaded neck 30 that is configured to receive a shower hose 32. A grip 34 may be coupled to the ventral side 20 of the handle portion. The grip 34 has a plurality of radial ridges 36 to accommodate a user's fingers therebetween and prevent slippage.

A valve 38 is coupled within the water flow channel 22 and has a valve control 40 extending through the handle portion 14. The valve control 40 may be a slider switch 42 having a button 44 coupled to the valve 38 and slidable within a channel 46 extending through one of a left side or a right side 48 of the handle portion. The slider switch 42 progressively moves the valve 38 between fully closed and fully open states.

A soap dispenser 48 is selectively engageable within a cavity 50 extending through the dorsal side 18 of the handle portion adjacent the valve 38. An outer face 52 of the soap dispenser has a profile matching the negative space of the cavity 50 to allow the soap dispenser 48 when engaged with the showerhead 12 to appear integral with the handle portion 14. The cavity 50 and a corresponding inner side 54 of the soap dispenser have rounded corners to facilitate engagement.

The soap dispenser 48 has a storage compartment 56 configured to store liquid soap and a nozzle 58 in fluid communication with the storage compartment 56 and the valve 38. The nozzle 58 extends from the inner side 54 and has a nipple 60 to engage the valve 38. The valve control 40 regulates the flow of liquid soap into the water flow channel 22. The outer face 52 may be transparent to show the content level of the storage compartment 56. The soap dispenser 48 may be a disposable cartridge or may alternatively have a refill aperture 62 extending through an upper side 64 to the storage compartment 56. The refill aperture 62 has a selectively removable cap 66 that mounts flush to the upper side 64 when engaged. A latch 68 is coupled to a lower side 70 of the soap dispenser. The latch 68 is selectively engageable with a latch receptacle 72 extending below the cavity 50 to maintain the soap dispenser 48 engaged with the showerhead 12. The latch 68 may be U-shaped and has a tooth 74. The latch 68 flexes under pressure when the soap dispenser 48 is pushed into the cavity 50 and then rebounds to snap the tooth 74 into a corresponding recession 76 within the latch receptacle 72. The latch 68 is lightly bent in by the user to disengage the soap dispenser 48 from the showerhead 12.

In use, the storage compartment 56 is filled with liquid soap and the soap dispenser 48 is engaged within the cavity 50. When the shower is on, the slider switch 42 is then manipulated to release the liquid soap into the flow of water coming through the water flow channel 22 to release soapy water through the plurality of flow apertures 26. To rinse, the user then adjusts the slider switch 42 to fully close the valve 38.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A soap dispenser showerhead comprising:
a showerhead comprising a handle portion and a head portion, the handle portion having a dorsal side and a ventral side, a water flow channel extending through a bottom side of the handle portion up through the head portion to be released through a plurality of flow apertures, the bottom side having a threaded neck that is configured to receive a shower hose;
a valve coupled to the showerhead, the valve being coupled within the water flow channel and having a valve control extending through the handle portion; and
a soap dispenser, the soap dispenser being selectively engageable within a cavity of the handle portion of the showerhead adjacent the valve, the soap dispenser having a storage compartment and a nozzle, the storage compartment being configured to store liquid soap and the nozzle being in fluid communication with the storage compartment and the valve, the valve control regulating the flow of liquid soap into the water flow channel.

2. The soap dispenser showerhead of claim 1 further comprising the cavity extending through the dorsal side of the handle portion and an outer face of the soap dispenser having a profile matching the negative space of the cavity, the soap dispenser when engaged with the showerhead thus appearing integral with the handle portion.

3. The soap dispenser showerhead of claim 2 further comprising the outer face being transparent to show the content level of the storage compartment.

4. The soap dispenser showerhead of claim 1 further comprising a latch coupled to a lower side of the soap dispenser, the latch being selectively engageable with a latch receptacle extending below the cavity.

5. The soap dispenser showerhead of claim 4 further comprising the latch being U-shaped and having a tooth, the latch being flexible such that it flexes under pressure when the soap dispenser is pushed into the cavity and then rebounds to snap the tooth into a corresponding recession within the latch receptacle, the latch being lightly bent in by a user to disengage the soap dispenser from the showerhead.

6. The soap dispenser showerhead of claim 1 further comprising the nozzle extending from an inner side of the soap dispenser, the nozzle having a nipple to engage the valve.

7. The soap dispenser showerhead of claim 1 further comprising the valve control being a slider switch, the slider switch having a button coupled to the valve and slidable within a channel extending through the handle portion, the slider switch progressively moving the valve between fully closed and fully open states.

8. The soap dispenser showerhead of claim 7 further comprising the channel extending through one of a left side or a right side of the handle portion.

9. The soap dispenser showerhead of claim 1 further comprising the handle portion being contoured to create an ergonomic shape.

10. The soap dispenser showerhead of claim 1 further comprising a grip coupled to the ventral side of the handle portion.

11. The soap dispenser showerhead of claim 1 further comprising the grip having a plurality of radial ridges to accommodate a user's fingers therebetween.

12. The soap dispenser showerhead of claim 1 further comprising the showerhead having an adjustment ring coupled around the head portion, the adjustment ring being in operational communication with the plurality of flow apertures to create different flow patterns and pressures.

13. The soap dispenser shower head of claim 1 further comprising the soap dispenser having a refill aperture extending through an upper side of the soap dispenser to the storage compartment, the refill aperture having a selectively removable cap, the cap mounting flush to the upper side when engaged.

14. The soap dispenser shower head of claim 1 further comprising the cavity and a corresponding inner side of the soap dispenser having rounded corners.

15. A soap dispenser showerhead comprising:
a showerhead comprising a handle portion and a head portion, the handle portion being contoured to create an ergonomic shape and having a dorsal side and a ventral side, a water flow channel extending through a bottom side of the handle portion up through the head portion to be released through a plurality of flow apertures, an adjustment ring being coupled around the head portion and in operational communication with the plurality of flow apertures to create different flow patterns and pressures, the bottom side having a threaded neck that is configured to receive a shower hose;
a grip coupled to the ventral side of the handle portion, the grip having a plurality of radial ridges to accommodate a user's fingers therebetween;
a valve coupled to the showerhead, the valve being coupled within the water flow channel and having a valve control extending through the handle portion, the valve control being a slider switch, the slider switch having a button coupled to the valve and slidable within a channel extending through one of a left side or a right side of the handle portion, the slider switch progressively moving the valve between fully closed and fully open states;
a soap dispenser, the soap dispenser being selectively engageable within a cavity of the handle portion of the showerhead adjacent the valve;
the cavity extending through the dorsal side of the handle portion, an outer face of the soap dispenser having a profile matching the negative space of the cavity, the soap dispenser when engaged with the showerhead thus appearing integral with the handle portion, the cavity and a corresponding inner side of the soap dispenser having rounded corners;
the soap dispenser having a storage compartment and a nozzle, the storage compartment being configured to store liquid soap and the nozzle being in fluid communication with the storage compartment and the valve, the nozzle extending from the inner side of the soap dispenser and having a nipple to engage the valve, the valve control regulating the flow of liquid soap into the water flow channel, the outer face being transparent to show the content level of the storage compartment, the soap dispenser having a refill aperture extending through an upper side of the soap dispenser to the storage compartment, the refill aperture having a selectively removable cap, the cap mounting flush to the upper side when engaged; and
a latch coupled to a lower side of the soap dispenser, the latch being selectively engageable with a latch receptacle extending below the cavity, the latch being U-shaped and having a tooth, the latch being flexible such that it flexes under pressure when the soap dispenser is pushed into the cavity and then rebounds to snap the tooth into a corresponding recession within the latch receptacle, the latch being lightly bent in by the user to disengage the soap dispenser from the showerhead.
